(19) United States
(12) Patent Application Publication
(10) Pub. No.: US 2003/0167201 A1
(43) Pub. Date: Sep. 4, 2003

(54) Product purchase/product development support method and product purchase/product development support apparatus

(76) Inventor: Masahiko Yamano, Hiroshima-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/396,471

(22) Filed: Mar. 26, 2003

Related U.S. Application Data
(63) Continuation of application No. PCT/JP00/06614, filed on Sep. 26, 2000.

(51) Int. Cl. G06F 17/60

(52) U.S. Cl. 705/10; 705/26

(57) ABSTRACT

There is disclosed a product purchase/product development support method of providing various information to a consumers who purchases a textile product and a textile maker which desires to participate in purchase and development of the textile product by a service providing server via Internet to perform various supports, the method comprising a step of reading background information from a background database disposed in, fashion information from a fashion database, and consumers information from a consumers information database and synthesizing these image information to output consumers simulated fitting image information to the information terminal by synthesized image calculation means disposed in.

### CROSS-REFERENCE TO RELATED APPLICATIONS

This is a Continuation Application of PCT Application No. PCT/JP00/06614, filed Sept. 26, 2000, which was not published under PCT Article 21(2) in English.

### BACKGROUND OF THE INVENTION

1. Field of the Invention

The present invention relates to a product purchase/product development support method and product purchase/product development support apparatus in which consumers [those who purchase (consume) products made by makers such as a textile maker, food product maker, and interior associated product maker are supported in purchasing a product, or the maker is supported in developing the product, and relates to a product purchase/product development support method and product purchase/product development support apparatus in which living culture can be enhanced from a consumers consumption aspect.

2. Description of the Related Art

An industrial structure of a living associated field of the consumers has been supported and has grown by an economic system of mass production, mass consumption, and mass disposal of the 20th century. In this economic system, it is an object to enrich a material aspect and thereby enhance living culture of the consumers. Moreover, the consumers have also grown in a situation in which the people simply purchase the products produced by a company, in order to overcome a situation in which products are running short.

However, in modern product surplus situations, the purchase object of the consumers (consumers) with respect to the products has been turned to enhancement of quality of life from the solving of the product shortage. Thereby, such changes of consumption behaviors of the consumers cannot be handled, and also become one cause for consumption recession.

As described above, it is obvious that a living associated field cannot be developed any more in the traditional economic system of the mass production, mass consumption, and mass disposal. It is considered that the makers (companies) of the living associated field provide products and services requested by the consumers and thereby the makers of the living associated field can sustain in the 21st century.

Therefore, in order for the makers of the living associated field to become organizations which can sustain in the 21st century, the previous economic system of the mass production, mass consumption, and mass disposal needs to be changed. An information system needs to be used to realize a “consumers service in which quick response (conforming) is regarded as important” in which the products, information, and services required by the consumers are provided to places required by the consumers in required amounts at times required by the consumers.

Here, the above-described present situations will concretely be described with respect to a textile field, food field, and interior associated field.

<Textile Field>

Small companies by subcontracts have produced a large amount of products of uniform standard based on patterns of textile makers. In this production method, for example, a domestic maker follows a trend of an advanced fashion district of Europe and United States to meet the needs of the consumers in the field of fashion.

<Food Field>

In recent years, needs for natural foods have been enlarged by safety thinking, there has been a demand on a consumers side for production of products such as crops and seafood whose producers are identified, and these consumers demands have been handled by dealing with products which are produced by organic farming and which are fresh from the farm.

<Interior Associated Field>

With the enlargement of product lines or product items, various kinds of product groups are prepared to meet diversified needs of the consumers. That is, in these living culture associated industries, the diversified consumers needs have been handled by import of culture from abroad, consideration to a safety aspect, or production of various kinds.

However, in the future, diversification of the consumers needs is further expected in the living culture aspect, the handling of plan, production, and distribution is requested to be matched to lifestyles of living individuals. However, there comes a situation in which it is impossible to satisfy the requirement without an information-oriented living culture associated field.

On the other hand, the change of a population constitution on the consumers side in the living culture associated field will raise a large problem in the future. That is, the conventional industrial system which has been dependent on the mass production, mass consumption, and mass disposal cannot grow in the 21st century of an aging society with fewer children. This can easily be imagined, and there has been a demand for a new system in which an information technique is used in stages of plan, production, and distribution on the consumers side.

Therefore, as described above, the living culture associated field has a situation in which it is difficult to grow in the aging society with fewer children of the 21st century, unless the new system is constructed using the information technique.

For example, to meet the diversified needs of the consumers, in the textile field the fashion is handled by importing and following the overseas trend.

Moreover, the needs have been met by the change of a production method in a production place or direct sales from the production place through a reviewed distribution channel in the food field, and by various kind production in the living associated field. However, it is a fact that the solution by the reviewing of the existing plan, production, and distribution in this manner has reached a limit point. This is one cause for the present consumption recession, and the system which meets the diversified needs of consumers does not exist.

<Textile Field>

Although considerable diversities have been seen in the consumers fashion sense due to the influence of today's video media, existing textile makers have not taken the fashion sense of the consumers into the planning. The trend is still imported from abroad, designs of some of famous designers are used, and this field has been stiffened.

<Food Field>

There have been demands for consideration of the health and safety of consumers with respect to food, and for consideration of the number of consumers who live alone, which is expected to increase in an aging society with fewer children. However, there is still much hope for consumers self management, and this causes consumption fear of the consumers with respect to the foods.

<Interior Associated Field>

In the interior associated field, lineups of products are diversified with the diversification of the consumers needs. As a result, product lines or product items of companies have been enlarged, product management has become complicated, a relation between the companies and consumers has been weakened, and a width of selection of products by the consumers has been narrowed.

The present invention has been developed based on the above-described circumstances, and a main object thereof is to provide a product purchase/product development support method and product purchase/product development support apparatus in which living culture can be enhanced from a consumption aspect of consumers. Moreover, a sub-object is to provide a product purchase/product development support method and product purchase/product development support apparatus in which consumers demands are quickly handled, to enhance a quick response.

### BRIEF SUMMARY OF THE INVENTION

According to a first aspect of the present invention, there is provided a product purchase/product development support method of providing various information to a consumers who purchases a textile product and a textile maker which desires to participate in purchase and development of the textile product by a service providing server via a network to perform various supports, the method comprising:

a step of suggesting consumers information including at least body shape size information and appearance image information of the consumers who uses an information terminal to be stored into a consumers information database disposed in the service providing server via the consumers information terminal connected to the network;

a step of suggesting fashion information of a product of the textile maker to be stored in a fashion database disposed in the service providing server via a textile maker's information terminal connected to the network;

a step of reading background information from a background database, fashion information from the fashion database, and consumers information from the consumers information database disposed in the service providing server and synthesizing these image information to prepare consumers simulated fitting image information by synthesized image calculation means disposed in the service providing server, when a simulated fitting request is inputted into the service providing server from the consumers information terminal;

a step of transmitting the consumers simulated fitting image information to the consumers information terminal by the service providing server; and

a step of receiving payment of an information listing charge by a service provider which owns the service providing server from the textile maker whose fashion information is registered in the fashion database.

According to a second aspect of the present invention, there is provided a product purchase/product development support method of providing various information to a consumers who purchases a textile product and a textile maker which desires to participate in purchase and development of the textile product by a service providing server via a network to perform various supports, the method comprising:

a step of suggesting a consumers fashion design which is inputted via a consumers information terminal connected to the network and which is prepared by the consumers to be stored into a consumers fashion database disposed in the service providing server;

a step of transmitting the consumers fashion design stored in the consumers fashion database to a textile maker's information terminal connected to the network to advertise for a textile maker which commercializes the consumers fashion design by fashion design processing means disposed in the service providing server, determining the textile maker for commercialization from textile makers which have responded to the advertisement, and storing sewing information of a pattern necessary for the commercialization into the fashion database disposed in the service providing server from the determined textile maker;

a step of suggesting consumers information including at least body shape size information and appearance image information of the consumers who uses the consumers information terminal to be stored into a consumers information database disposed in the service providing server via the consumers information terminal;

a step of reading background information from a background database, fashion information from the fashion database, and consumers information from the consumers information database disposed in the service providing server by the service providing server, and synthesizing these image information to prepare consumers simulated fitting image information by synthesized image calculation means disposed in the service providing server, when a simulated fitting request is inputted into the service providing server from the consumers information terminal;

a step of transmitting the consumers simulated fitting image information to the consumers information terminal by the service providing server; and

a step of paying a design use fee to the consumers who has prepared the consumers fashion design directly from the textile maker or via a service provider, when the consumers fashion design stored in the consumers fashion database is stored in the fashion database and opened to the public via the consumers information terminal and the opened fashion is used.

According to a third aspect of the present invention, there is provided a product purchase/product development support apparatus comprising: a service providing server to provide various information to a consumers who purchases a textile product and a textile maker which desires to participate in purchase and development of the textile product via a network, so that various supports are performed,

the service providing server comprising: a consumers information database; a fashion database; a background database; and synthesized image calculation means,

wherein the consumers information database stores consumers information inputted from the consumers information terminal and comprising at least body shape size information and appearance image information of the consumers who uses the consumers information terminal,

the service providing server suggests fashion information of a product of the textile maker, which is inputted from a textile maker's information terminal connected to the network, to be stored into the fashion database,

the service providing server stores background information into the background database, and the synthesized image calculation means reads the background information from the background database, fashion information from the fashion database, and consumers information from the consumers information database and synthesizes these image information to prepare consumers simulated fitting image information, when receiving a simulated fitting request from the consumers information terminal.

According to a fourth aspect of the present invention, there is provided a product purchase/product development support apparatus comprising: a service providing server to provide various information to a consumers who purchases a textile product and a textile maker which desires to participate in purchase and development of the textile product via a network, so that various supports are performed,

the service providing server comprising: a consumers fashion database; fashion design processing means; a fashion database; a consumers information database; a background database; synthesized image calculation means; and order acceptance processing means,

wherein the service providing server suggests a consumers fashion design which is inputted from a consumers information terminal connected to the network and which is prepared by the consumers to be stored in the consumers fashion database,

the fashion design processing means transmits the consumers fashion design stored in the consumers fashion database to a textile maker's information terminal connected to the network to advertise for a textile maker which commercializes the consumers fashion design, determines the textile maker for commercialization from textile makers which have responded to the advertisement, and suggests sewing information of a pattern necessary for the commercialization to be stored into the fashion database from the determined textile maker,

the consumers information database suggests consumers information comprising at least body shape size information and appearance image information of the consumers who uses the consumers information terminal to be stored via the consumers information terminal,

the synthesized image calculation means reads background information from the background database, fashion information from the fashion database, and consumers information from the consumers information database, synthesizes these image information to prepare consumers simulated fitting image information, and transmits the consumers simulated fitting image information to the consumers information terminal, when a simulated fitting request is inputted into the service providing server from the consumers information terminal, and

the order acceptance processing means accepts an order for a product from the consumers information terminal, after the consumers simulated fitting image information is received in the consumers information terminal, and instructs the information terminal of the textile maker which has commercialized the consumers fashion design to ship the product.

According to a fifth aspect of the present invention, there is provided a product purchase/product development support method of providing various information to a consumers who purchases a food product and a food product maker which desires to participate in purchase and development of the food product by a service providing server via a network to perform various supports, the method comprising:

a step of suggesting a content of check of an eating habit including a personal health condition of the consumers by a nutrition management adviser who has contracted with a service provider owning the service providing server to be stored in a consumers information database disposed in the service providing server via the service providing server;

a step of analyzing a content stored in the consumers information database to prepare food product manufacturing/developing information for manufacturing/developing the food product fit for consumers needs by analysis processing means disposed in the service providing server;

a step of suggesting an existing food product list from a food product maker's information terminal connected to the network and a new food product list newly developed based on the food product manufacturing/developing information stored in an analysis database to be stored in a food product database disposed in the service providing server; and

a step of searching the consumers information database, a menu database in which all menus are stored, a recipe database in which a recipe corresponding to the menu is stored, and the food product database, and supplying a menu for each consumers, food products necessary for the menu, and recipe of the food products to a consumers information terminal connected to the network by menu preparation means disposed in the service providing server.

According to a sixth aspect of the present invention, there is provided a product purchase/product development support apparatus comprising: a service providing server to provide various information to a consumers who purchases a food product and a food product maker which desires to participate in purchase and development of the food product via a network, so that various supports are performed,

the service providing server comprising: a consumers information database; a menu database; a recipe database; an analysis database; a food product database; eating habit check result input means; analysis processing means; and menu preparation means,

wherein the eating habit check result input means suggests a content of check of an eating habit including a personal health condition of the consumers by a nutrition management adviser who has contracted with a service provider owning the service providing server to be stored in the consumers information database;

the analysis processing means analyzes the content stored in the consumers information database to prepare food product manufacturing/developing information for manufacturing/developing the food product fit for consumers needs;

the analysis processing means suggests the food product manufacturing/developing information prepared by the analysis processing means to be stored in the analysis database to transmit the stored food product manufacturing/developing information to a food product maker's information terminal connected to the network, and

suggests an existing food product list from the food product maker information terminal and/or a new food product list newly developed based on the food product manufacturing/developing information stored in the analysis database to be stored in the food product database,

the menu database stores all menus,

the recipe database registers a recipe for each menu, and

the menu preparation means transmits the menu for each consumers, food products necessary for the menu, and recipe of the food products to a consumers information terminal connected to the network based on the consumers information database, menu database, recipe database, and food product database.

According to a seventh aspect of the present invention, there is provided a product purchase/product development support method of providing various information to a consumers who purchases an interior associated product and an interior associated product maker which desires to participate in purchase and development of the interior associated product by a service providing server via a network to perform various supports, the method comprising:

a step of suggesting product information of each interior associated product maker from an information terminal of the interior associated product maker connected to the network to be stored into a product database disposed in the service providing server;

a step of suggesting an information terminal of the consumers connected to the network to input a search condition for searching the interior associated product, selecting a product satisfying the search condition from the products stored in the product database, when the search condition is inputted, and suggesting image information of the selected product to be stored in a personal product database disposed in the service providing server;

a step of suggesting the consumers information terminal to store the image information concerning a house into a house information database disposed in the service providing server by the service providing server;

a step of suggesting the consumers information terminal to store personal house information inputted from the consumers information terminal as the image information into a personal house information database disposed in the service providing server by the service providing server;

a step of synthesizing the image information stored in the personal product database and image information stored in the personal house information database to prepare consumers simulated use image information by image processing means disposed in the service providing server; and

a step of transmitting the consumers simulated use image information synthesized by the image processing means to the consumers information terminal.

According to an eighth aspect of the present invention, there is provided a product purchase/product development support apparatus: comprising a service providing server to provide various information to a consumers who purchases an interior associated product and an interior associated product maker which desires to participate in purchase and development of the interior associated product via a network, so that various supports are performed,

the service providing server comprising: a product database; product search means; a personal product database; a personal house information database; and image processing means,

wherein the service providing server suggests product information of each interior associated product maker from information terminals of a plurality of interior associated companies connected to the network to be stored into the product database,

the product search means selects a product satisfying a search condition from the product database, when the search condition for searching the interior associated product is inputted from an information terminal of the consumers connected to the network, and stores image information of the selected product into the personal product database,

the service providing server suggests the consumers information terminal to store personal house information as the image information into the personal house information database, and

the image processing means synthesizes the image information stored in the personal product database and image information stored in the personal house information database to prepare consumers simulated use image information, and transmits the prepared consumers simulated use image information to the consumers information terminal.

According to the present invention, there can be provided a product purchase/product development support method and product purchase/product development support apparatus in which living culture can be enhanced from a consumption aspect of a consumers. Moreover, there can be provided a product purchase/product development support method and product purchase/product development support apparatus in which a demand of the consumers is quickly handled and quick response is enhanced.

### BRIEF DESCRIPTION OF THE SEVERAL VIEWS OF THE DRAWING

FIG. 1 is a schematic diagram showing a network system including a product purchase/product development support apparatus using a network, to which a product purchase/product development support method is applied according to a first embodiment of the present invention;

FIG. 2 is a block diagram showing a main constitution of a service providing server of FIG. 1;

FIG. 3 is a sequence diagram in which the service providing server of FIG. 1 indicates procedures of various supports concerning product purchase/product development to a consumers and textile maker;

FIG. 4 is a block diagram showing the main constitution of the service providing server assembled into the product purchase/product development support apparatus using the network, to which the product purchase/product development support method is applied according to a second embodiment of the present invention;

FIG. 5 is a sequence diagram in which the service providing server according to the second embodiment of the present invention indicates the procedures of various supports concerning the product purchase/product development to the consumers and textile maker;

FIG. 6 is a schematic diagram showing the network system including the product purchase/product development support apparatus using the network, to which the product purchase/product development support method is applied according to a third embodiment of the present invention;

FIG. 7 is a block diagram showing the main constitution of the service providing server of FIG. 6;

FIG. 8 is a sequence diagram in which the service providing server according to the third embodiment of the present invention indicates the procedures of various supports concerning the product purchase/product development to the consumers and food product maker;

FIG. 9 is a block diagram showing a main constitution of a different example of the service providing server of FIG. 6;

FIG. 10 is a block diagram showing a main constitution of another example of the service providing server of FIG. 6;

FIG. 11 is a sequence diagram in which the service providing server according to a modification example of the third embodiment of the present invention indicates the procedures of various supports concerning the product purchase/product development to the consumers and food product maker;

FIG. 12 is a schematic diagram showing the network system including the product purchase/product development support apparatus using the network, to which the product purchase/product development support method is applied according to a fourth embodiment of the present invention; and

FIG. 13 is a sequence diagram in which the service providing server according to the fourth embodiment of the present invention indicates the procedures of various supports concerning the product purchase/product development to the consumers and interior maker.

### DETAILED DESCRIPTION OF THE INVENTION

Embodiments of the present invention will be is described hereinafter with reference to the drawings.

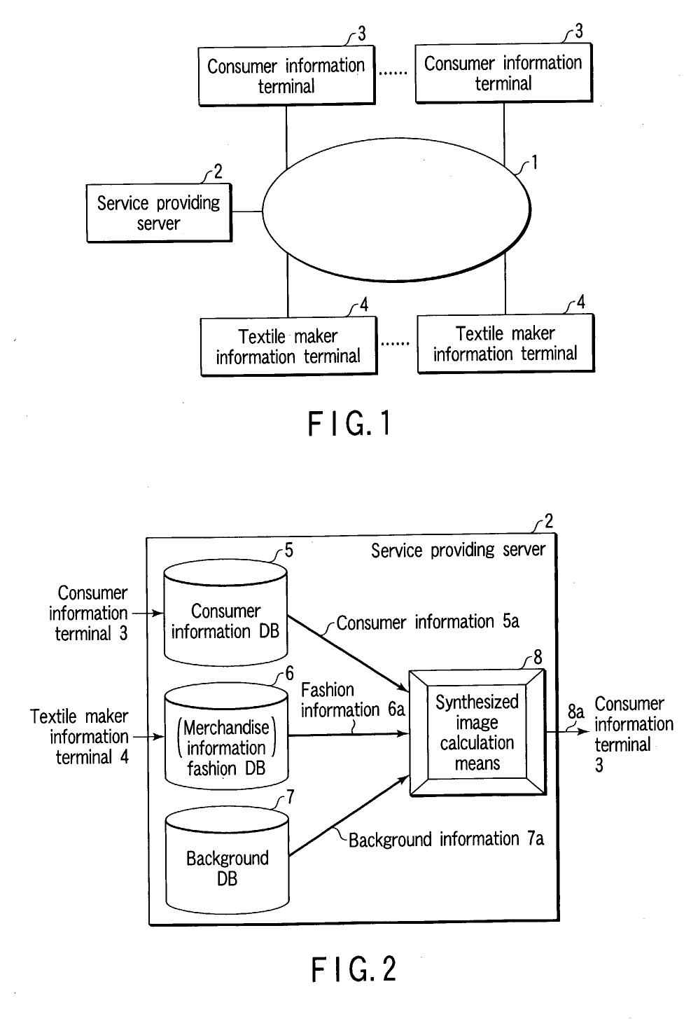

FIG. 1 is a schematic diagram showing a network system including a product purchase/product development support apparatus using a network, to which a product purchase/product development support method is applied according to a first embodiment of the present invention.

Internet 1, which is a network, is connected to a service providing server 2 as a product purchase/product development support apparatus handled by a service provider which provides a product purchase/product development support service. This service providing server 2 is constituted by an information processing terminal, such as a computer, and has a function of the server with respect to the Internet 1.

Here, the Internet 1 may be either wired or wireless, as long as digital communication is performed. Moreover, a public line is also sometimes included.

The Internet 1 is connected not only to the service providing server 2 but also to a plurality of information terminals 3 of consumers who purchase textile products, and a plurality of information terminals (textile maker information terminals) 4 of textile makers that desire to participate in purchase and development of the textile products.

In each consumers information terminal 3 and textile maker information terminal 4, a browser is incorporated as browsing software which can freely access the homepage of the service providing server 2 via the Internet 1. Moreover, each consumers information terminal 3 and textile maker information terminal 4 has an E-mail transmission/reception function.

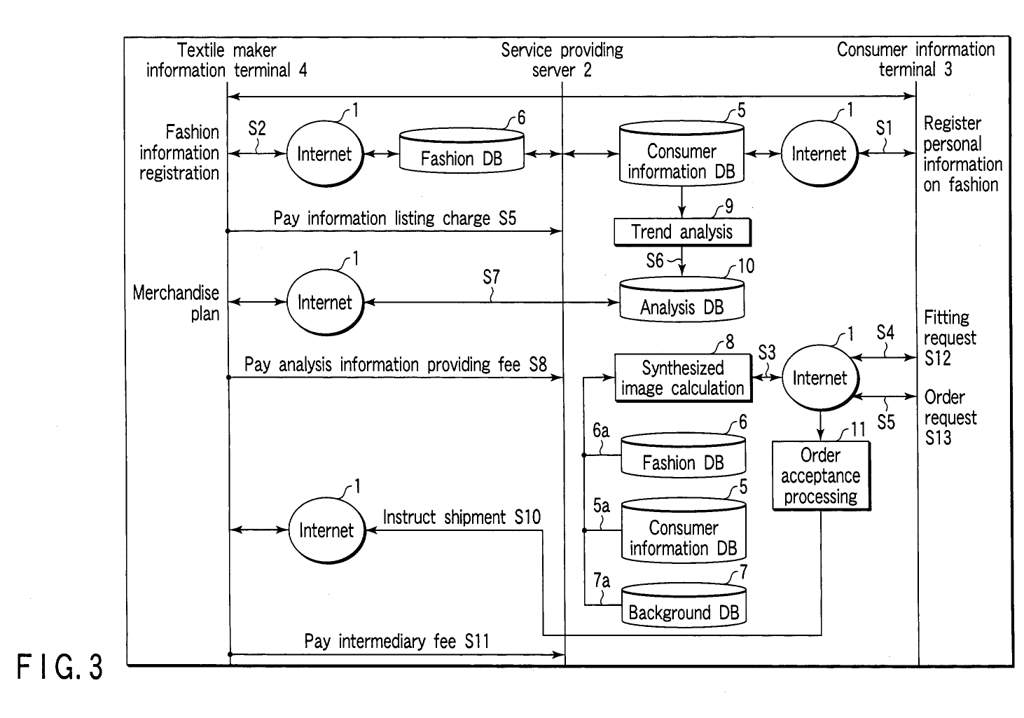

FIG. 2 is a block diagram showing a schematic constitution of the service providing server 2. The server includes: a consumers information database (consumers information DB) 5; a fashion database (fashion DB) 6; a background database (background DB) 7; trend analysis means 9, described later; an analysis database (analysis DB) 10 and order acceptance processing means (FIG. 3) 11.

The service providing server 2 suggests the consumers information terminal 3 to store consumers information 5a, including at least body shape and size information and appearance image information of a consumers who uses the consumers information terminal, such as a photograph including the whole consumers and interest or taste of the consumers for fashion into the consumers information DB 5 via the consumers information terminal 3. In this case, the consumers information DB 5 is stored in a region allocated to each consumers.

The service providing server 2 suggests the textile maker information terminal 4 to store fashion information 6a of its own product into the fashion DB 6. In this case, the fashion DB 6 is stored in a region allocated to each maker.

In the background DB 7, background information (landscape information) 7a is stored such as a mountain, sea, and town.

The synthesized image calculation means 8 reads the background information 7a from the background DB 7, fashion information 6a from the fashion DB 6, and consumers information 5a from the consumers information DB 5, and synthesizes this image information to prepare consumers simulated fitting image information 8a.

The trend analysis means 9 performs trend analysis of a fashion field based on the consumers information 5a, including the consumers interest or taste for fashion, in the consumers information stored in the consumers information DB 5. The analysis DB 10 stores a trend analysis result of the trend analysis means 9.

When the consumers checks the consumers simulated fitting image information 8a and likes the textile product of the textile maker, the order acceptance processing means 11 accepts a purchase request from the consumers information terminal 3, accepts an order, and transmits (gives) a shipping instruction to the information terminal 4 of the textile maker corresponding to the order.

FIG. 3 is a sequence diagram in which the service providing server 2 assembled in this network system indicates procedures of various supports concerning the product purchase/product development to the consumers and textile maker.

First, the consumers information 5a of the consumers who uses the consumers information terminal 3 is stored into the consumers information DB 5 from the consumers information terminal 3 connected to the Internet 1 (S1).

The fashion information of its own product is stored into the fashion DB 6 from the textile maker information terminal 4 connected to the Internet 1 (S2).

The consumers requires a simulated fitting request (S12) of the service providing server 2 from the consumers information terminal 3 (S4). Then, the synthesized image calculation means 8 disposed in the service providing server 2 reads the background information 7a from the background DB 7 disposed in the service providing server 2, fashion information 6a from the fashion DB 6, and consumers information from the consumers information DB 5, and synthesizes this image information to obtain consumers simulated fitting image information (S3).

The consumers simulated fitting image information (image information of fitting) 8a obtained from the service providing server 2 in this manner is transmitted to the consumers information terminal 3 connected to the Internet 1.

The consumers checks the consumers simulated fitting image information 8a, likes the textile product of the textile maker, and requires the order (S13) of the service providing server 2 (S13). Then, the order acceptance processing means 11 accepts the order and issues the shipping instruction to the information terminal 4 of the corresponding textile maker (S10).

After the shipping instruction is issued to the textile maker information terminal 4, the textile maker sends the corresponding textile product to the consumers who has placed the order in a certain method. Thereafter, the consumers pays the corresponding textile maker for the received textile product via a service company, and the textile maker which has sold the textile product pays an intermediary fee to the service company (S11).

On the other hand, the service providing server 2 reads the consumers information from the consumers information DB 5, analyzes the trend of the fashion field based on the information (S6), and stores the analysis result into the analysis DB 10. The analysis data stored in the analysis DB 10 is outputted to the textile maker information terminal 4 (S7), and the textile maker develops a new textile product based on the analysis data. Therefore, the textile maker pays an analysis information providing fee to the service provider who owns the service providing server 2 (S8).

Furthermore, the textile maker in which the fashion information is registered in the fashion DB 6 pays an information listing charge to the service provider which owns the service providing server 2 (S5).

According to the first embodiment described above, the following function/effect is obtained. The consumers inputs personal information on the fashion, that is, at least the body shape and size information and appearance image information, and consumers personal information including the interest in or taste for the textile product if necessary into the service providing server 2 via the consumers information terminal 3. Thereby, in the service providing server 2, the consumers personal information, fashion information of the textile maker, and consumers simulated fitting image information with which background information is synthesized are outputted to the consumers information terminal 3. The consumers simulated fitting image information is image information supposing that the consumers tries the textile product of the textile maker in various places in various time zones in various seasons. Therefore, the consumers grasps an image in which the person tries the product on, and can therefore obtain a support in purchasing the textile product.

In this case, it is possible to obtain the image information in which not only various kinds of textile products of the textile maker but also the same kind of all the textile products having different designs (all designs registered in the fashion DB) are tried on. Therefore, the consumers can purchase the desired textile product in any favorite place in any favorite time zone, and this is very convenient.

The consumers simulated fitting image information is given via the consumers information terminal 3. Therefore, even if the textile product is not instantly purchased, the information can be referred to in purchasing the textile product in the future. Additionally, the information is useful in finding the textile product suitable for that person.

As a result, it is possible to provide a necessary textile product to the consumers in a necessary amount at an adequate price, when necessary. Additionally, a trend analysis result is given to the textile maker based on the consumers information, and is therefore useful in developing the textile product suitable for the consumers needs.

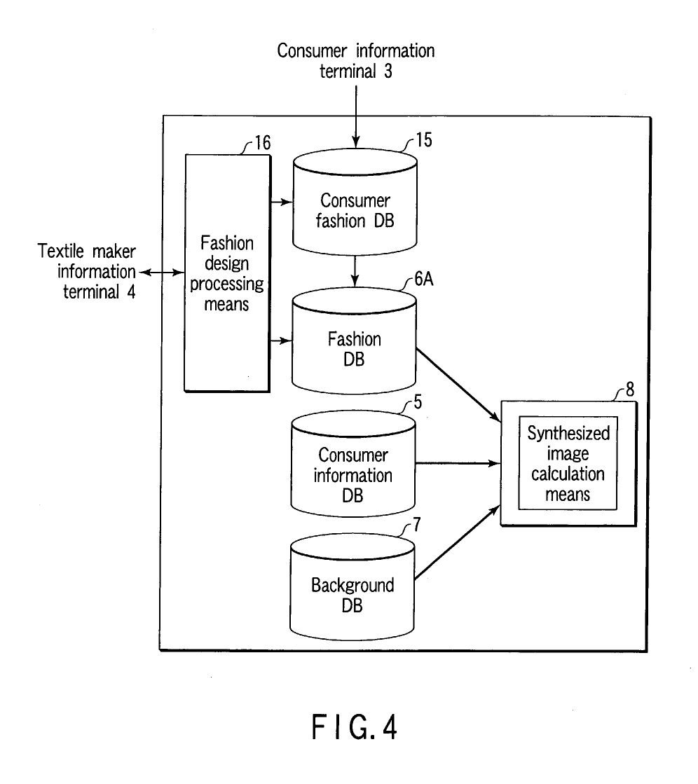

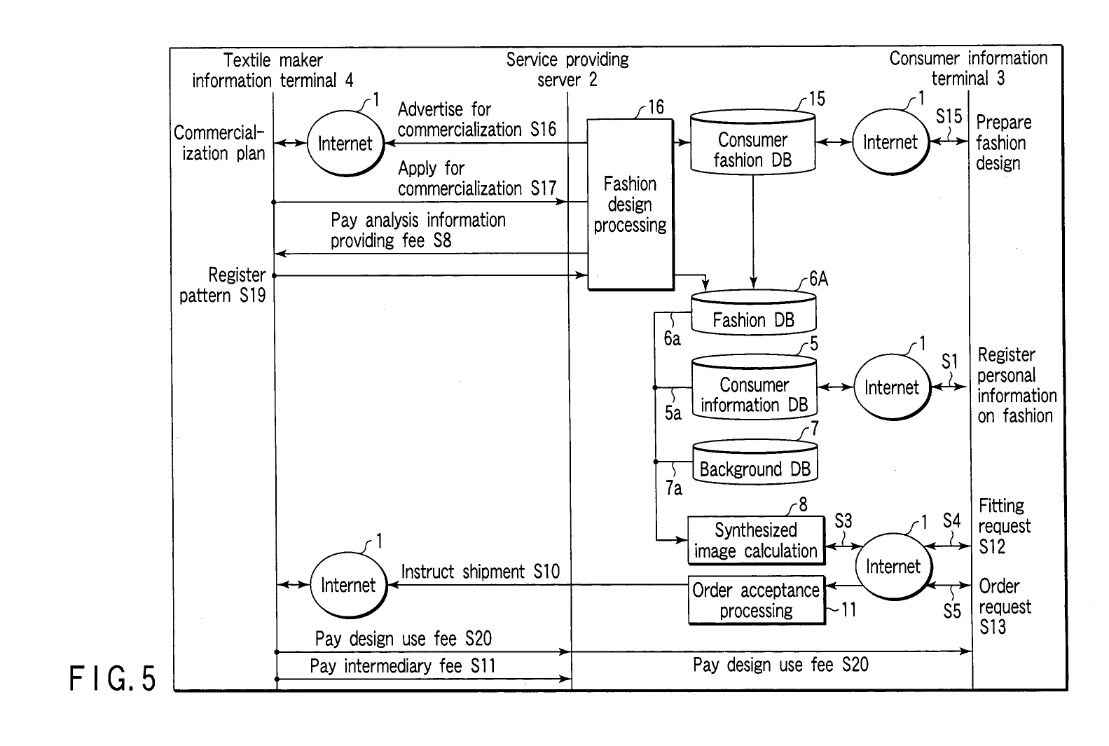

Next, a second embodiment of the present invention will be described with reference to FIGS. 4 and 5. In the first embodiment, the fashion information of the textile product of the textile maker is stored in the fashion DB 6. Here, the present embodiment is schematically different only in that the embodiment is based on the design of fashion prepared by the consumers without using the fashion information of the textile maker.

This will be described next. FIG. 4 is a block diagram showing the schematic constitution of the service providing server 2. Different from FIG. 2, a consumers fashion database (consumers fashion DB) 15, and fashion design processing means 16 are newly added.

The consumers fashion DB 15 stores a consumers fashion design which is inputted from the consumers information terminal 3 and which is prepared by the consumers.

The fashion design processing means 16 provides the consumers fashion design stored in the consumers fashion DB 15 to the textile maker information terminal 4 to advertise for a textile maker for commercializing the consumers fashion design, determines the textile maker for commercialization from textile makers which have responded to the advertisement, and stores sewing information of a pattern necessary for the commercialization into the fashion DB 6A from the determined textile maker for the commercialization.

FIG. 5 is a sequence diagram in which the service providing server 2 assembled into the network system indicates the procedures of various supports concerning the product purchase/product development to the consumers and textile maker.

First, the consumers fashion design which is inputted from the consumers information terminal 3 and which is prepared by the consumers is stored in the consumers fashion DB 15 disposed in the service providing server 2 (S15).

Next, the fashion design processing means 16 provides the consumers fashion design stored in the consumers fashion DB 15 to the textile maker information terminal 4 to advertise for the textile maker for commercializing the consumers fashion design (S16), determines the textile maker for the commercialization (S18) from the textile makers which have responded to the advertisement for the commercialization (S17), and stores the sewing information of the pattern necessary for the commercialization into the fashion DB 6A from the determined textile maker for the commercialization (S19).

The subsequent process is substantially similar to that of the first embodiment. That is, the consumers information including at least the body shape size information and appearance image information of the consumers who uses the consumers information terminal 3 is stored into the consumers information DB 5 disposed in the service providing server 2 from the consumers information terminal 3 (S1).

The simulated fitting request (S12) is inputted into the service providing server 2 from the consumers information terminal 3 (S4). Then, the service providing server 2 reads the background information 7a from the background DB 7 disposed in the service providing server 2, fashion information 6a from the fashion DB 6, and consumers information 5a from the consumers information DB 5. This image information is synthesized to obtain the consumers simulated fitting image information by the synthesized image calculation means 8 disposed in the service providing server 2 (S3).

The consumers simulated fitting image information (image information of the fitting) 8a obtained by the service providing server 2 in this manner is transmitted to the consumers information terminal 3 connected to the Internet 1.

The consumers checks the consumers simulated fitting image information 8a, likes the textile product of the textile maker, and sends the order request (S13) to the service providing server 2 (S5). Then, the order acceptance processing means 11 accepts the order and issues the shipping instruction to the information terminal 4 of the corresponding textile maker (S10).

After the shipping instruction is issued to the textile maker information terminal 4, the textile maker sends the corresponding textile product to the consumers who has placed the order. Thereafter, the consumers pays the corresponding textile maker for the received textile product via the service company, and the textile maker which has sold the textile product pays the intermediary fee to the service company (S11).

The consumers fashion design registered in the consumers fashion DB 15 is stored in the fashion DB 6A and opened to the public via the consumers information terminal 3, and the opened consumers fashion design is used. Then, the textile maker pays a design use fee to the consumers who has prepared the consumers fashion design (S20).

According to the second embodiment, when there is no satisfying fashion in the fashion of the textile maker stored in the fashion DB 6 described in the first embodiment, the consumers prepares the desired consumers fashion design, and the textile product is obtained based on the design. Additionally, the function/effect similar to that of the first embodiment can be obtained.

In the second embodiment described above, for the fashion design which is supposedly referred to by the consumers to prepare the fashion design, the existing design may be downloaded into the consumers information terminal 3 via Internet 1A.

FIG. 6 is a schematic diagram showing the network system including the product purchase/product development support apparatus using the network, to which the product purchase/product development support method is applied according to a third embodiment of the present invention.

Internet 1A which is the network is connected to a service providing server 2A as the product purchase/product development support apparatus handled by the service provider which provides the product purchase/product development support service. This service providing server 2A is constituted of one type of an information processing terminal, such as a computer, and acts as a server with respect to the Internet 1A.

Here, the Internet 1A may be either wired or wireless, as long as digital communication is performed. Moreover, a public line is also sometimes included.

The Internet 1A is connected not only to the service providing server 2A but also to a plurality of information terminals (consumers information terminals) 3A of consumers who purchase food products (product), and a plurality of information terminals (food product maker information terminals) 4A of food product makers which desire to participate in purchase and development of the food products.

In each consumers information terminal 3A and food product maker information terminal 4A, the browser is incorporated as the browsing software which can freely access the homepage of the service providing server 2A via the Internet 1A. Moreover, each consumers information terminal 3A and food product maker information terminal 4A have an E-mail transmission/reception function.

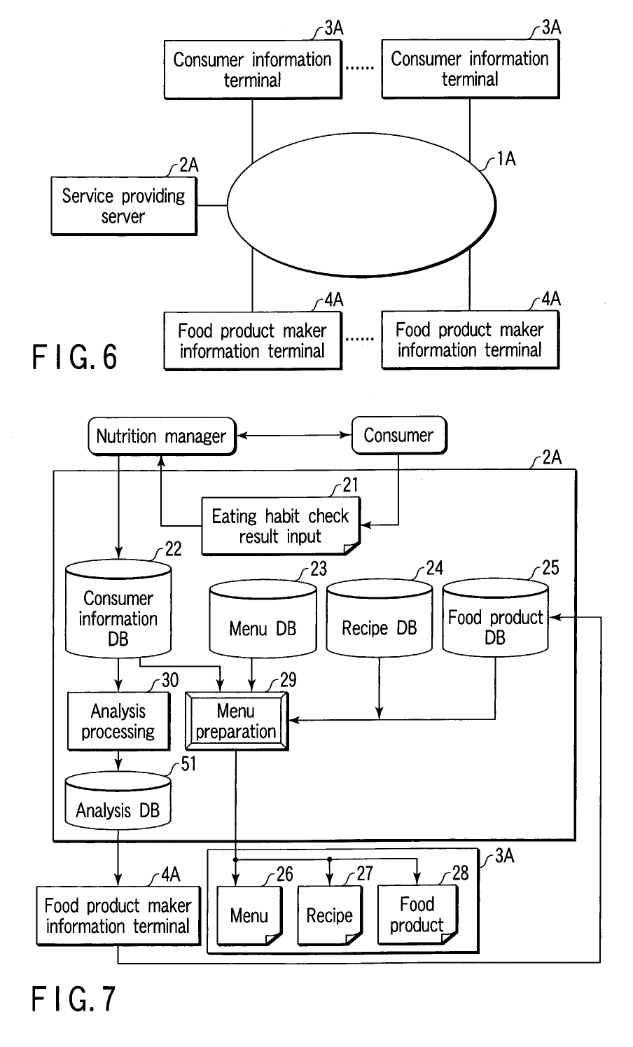

FIG. 7 is a block diagram showing the schematic constitution of the service providing server 2A. This is the product purchase/product development support apparatus, which provides various information for the consumers who purchases the food product and a food product maker which desires to participate in the purchase and development of the food product by the service providing server, via a network and performs various support.

The service providing server 2A comprises: a consumers information database (consumers information DB) 22; a menu database (menu DB) 23; a recipe database (recipe DB) 24; an analysis database (analysis DB) 31; a food product database (food product DB) 25; eating habit check result input means 21; analysis processing means 30; and menu preparation means 29.

The eating habit check result input means 21 is disposed for a nutrition management adviser (nutrition manager) who contracts with the service provider owning the service providing server 2A to store contents of check of an eating habit including a personal health condition of the consumers, such as information of a slightly high blood pressure, slight obesity, and diabetes into the consumers information DB 22. In this case, the service providing server 2A suggests the consumers information terminal 3A to store the information.

The analysis processing means 30 analyzes the content stored in the consumers information DB 22 to prepare the food product manufacturing/developing information for manufacturing/developing the food product suitable for the consumers needs.

The analysis DB 51 stores the food product manufacturing/developing information obtained by the analysis processing means 30, and can transmit the stored food product manufacturing/developing information to a food product maker information terminal.

The food product DB 25 stores an existing food product list from the food product maker information terminal 4A and/or a new food product list newly developed based on the food product manufacturing/developing information stored in the analysis DB 51. In this case, the service providing server 2A suggests the food product maker information terminal 4A.

The menu DB 23 stores all menus. The recipe DB 24 registers a recipe (preparing method) for each menu.

The menu preparation means 29 searches and transmits the menu for each consumers, food products necessary for the menu, and recipe of the food products to the consumers information terminal 3A based on the consumers information DB 22, menu DB 23, recipe DB 24, and food product DB 25.

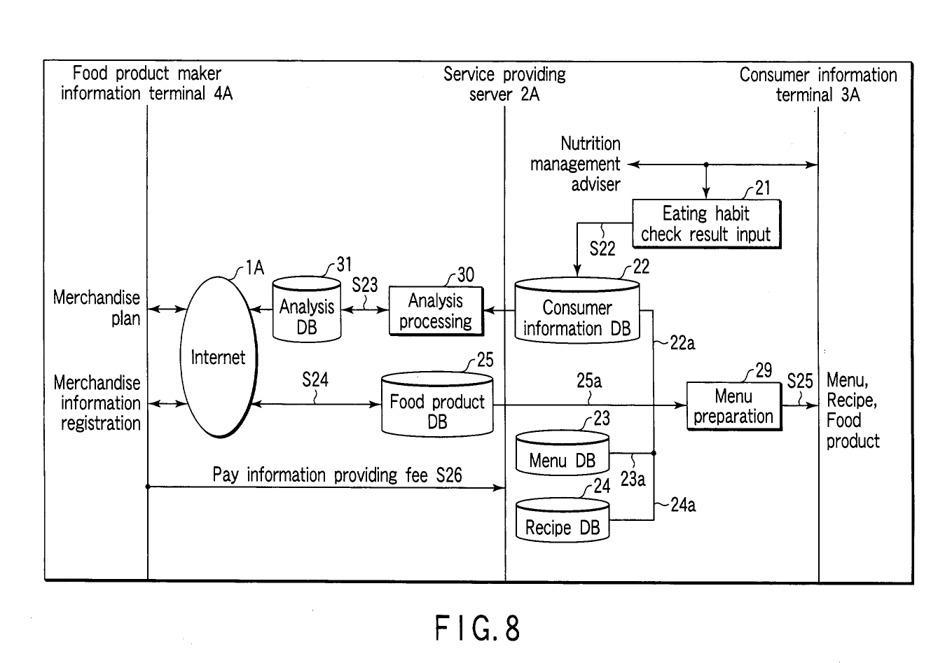

FIG. 8 is a sequence diagram in which the service providing server 2A incorporated in the network system indicates the procedures of various supports concerning the product purchase/product development to the consumers and food product maker.

First, the nutrition management adviser who contracts with the service provider owning the service providing server 2A stores the content of the check of the eating habit including the health condition of the consumers into the consumers information DB 22 (S22).

The analysis processing means 30 analyzes the content stored in the consumers information DB 22 to obtain the food product manufacturing/developing information for manufacturing/developing the food products suitable for the needs of the consumers (S23).

The existing food product list from the food product maker information terminal 4A and the new food product list newly developed based on the food product manufacturing/developing information stored in the analysis DB 51 are stored in the food product DB 25 disposed in the service providing server 2A (S24).

The menu preparation means 29 searches and transmits a menu 26 for each consumers, food products 28 necessary for the menu 26, and recipe 27 of the food products 28 to the consumers information terminal (3A) based on the consumers information DB 22, menu DB 23, recipe DB 24, and food product DB 25 (S25).

Finally, the food product maker owning the food product maker information terminal 4A pays an information providing fee to the service company which holds the service providing server 2A (S26).

In this manner, for the service providing server 2A, with respect to the consumers who owns the consumers information terminal 3A, menu information corresponding to the content of the consumers information DB 22 in the check concerning the consumers eating habit including the health condition, recipe information, and food product information for use in the menu are given to the consumers information terminal 3A. In this case, a menu for the health condition from a viewpoint of the eating habit is given to the consumers which is not healthy. For example, the menu of the food product having little neutral fat is provided to a consumers which has much neutral fat in a short time. Moreover, the menu of the well-balanced food products which can maintain health is provided to the healthy consumers in the short time. Therefore, this is remarkably convenient for maintaining/managing the health of the consumers. Furthermore, the service providing server 2A supplies the analysis result of the needs analyzed based on the content of the consumers information DB 22 to the food product maker information terminal 4A. The food product maker refers to the result in developing the new food products, and can further manufacture the food products appropriate for the needs of the consumers. Therefore, wasteful manufacturing/developing of the food products can be minimized.

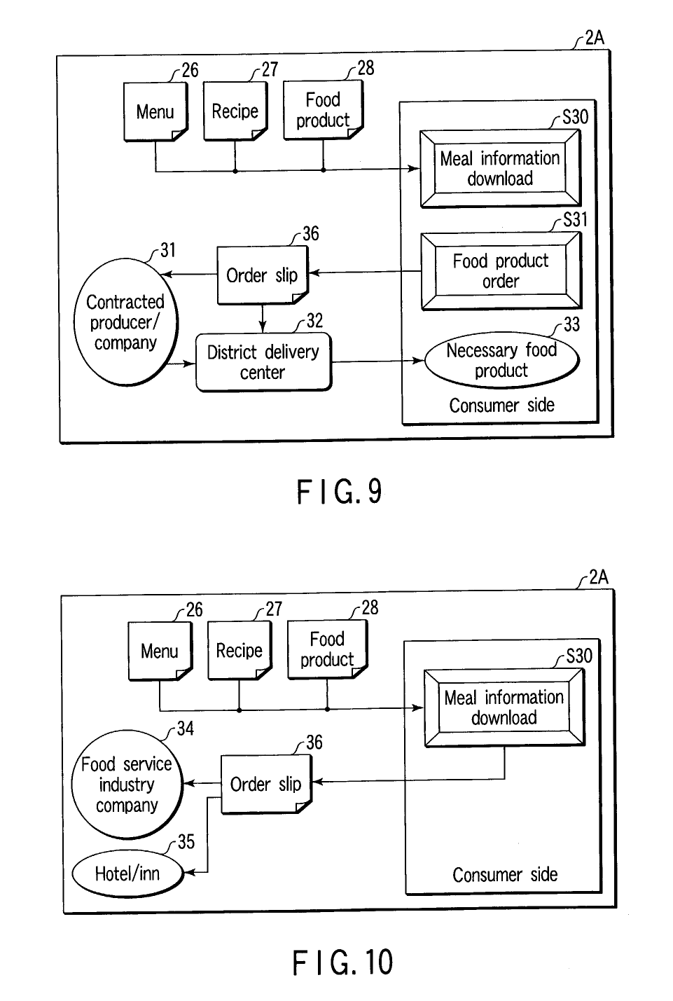

FIG. 9 is an explanatory view of a means for assuring safety of the food products by the service company, and delivering a required amount of the food products required by the consumers to a required designated place at a necessary time to enhance the quick response. That is, a service providing server 2B of the service company downloads meal information including the menu information 26, recipe information 27, and food product information 28 prepared as described above in the third embodiment into the consumers information terminal 3A owned by the consumers (S30). When the consumers uses the advice of the service company, the consumers makes an order for the food products based on the food products 28 (S31).

Then, order processing means 36 disposed in the service providing server 2B prepares an order slip to make the order to a contracted producer or production company 31, and instructs a district delivery center 32 to ship the products, and the district delivery center 32 sends necessary food products 33 to a place designated by the consumers.

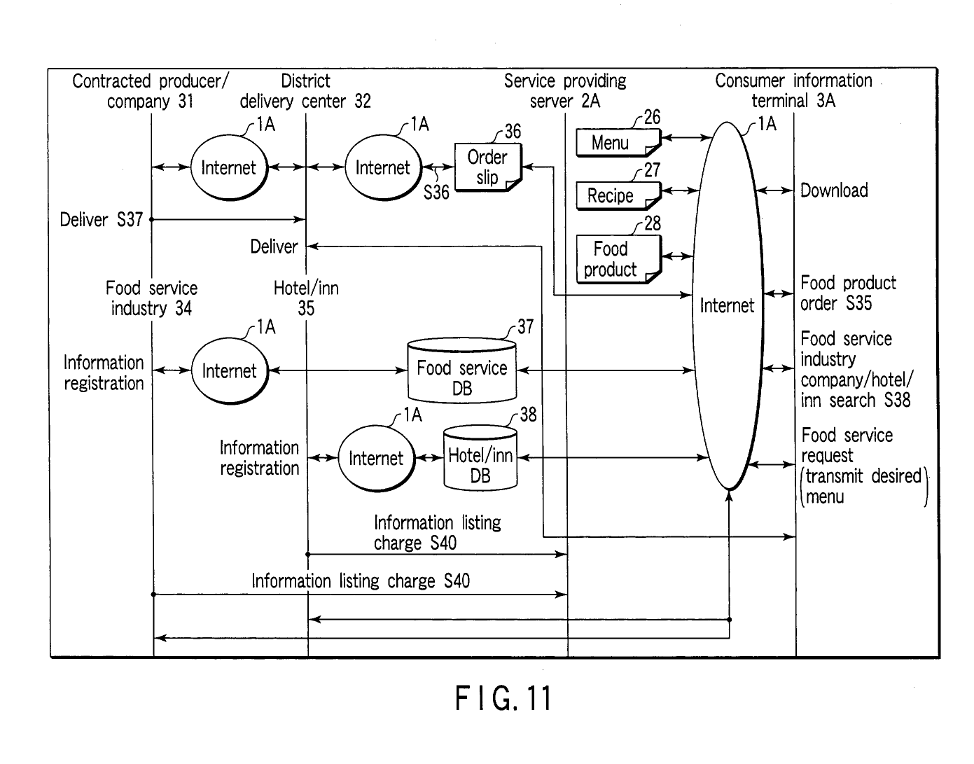

FIG. 10 shows means for a personal menu of meal in cooking companies such as a food service industry company and inn/hotel. That is, to take a menu desired by the consumers who has prepared meal information including the menu information 26, recipe information 27, and food product information 28, for example, as described above in the third embodiment into a meal menu of a food service industry 34 or hotel/inn 35 which contracts with the service company, the service company transmits the order slip of the prepared personal menu information of the meal beforehand to the food service industry 34 or hotel/inn 35 desired to be used by the consumers (S32). Thereby, the mean having the designated content can be taken in the designated food service industry 34 or hotel/inn 35 at a desired time of day.

FIG. 11 is a sequence diagram in which the service providing server 2A shown in FIGS. 9 and 10 indicates the procedures of various supports concerning the product purchase/product development to the consumers, district delivery center 32, and contracted producer/company 31. The consumers orders the food products from the homepage prepared by the service company based on a menu table prepared and provided by the service company (S35). The order processing means 36 disposed in the service providing server 2A of the service company performs an order acceptance process, prepares the order slip (S36), and instructs via the Internet 1A (S37), the district delivery center 32 or contracted producer/company 31 to ship the products.

On the other hand, when the consumers uses the food service industry company or hotel/inn 35 (S38), the consumers searches for a shop (food service shop) of the food service industry 34 or hotel/inn 35 from the homepage prepared by the service company, that is, a hotel/inn database (hotel/inn DB) 38 and/or food service industry database (food service DB) 37. The consumers own menu is sent to the desired food service shop or hotel/inn 35 (S39).

The food service shop or hotel/inn 35 lists own information in the database prepared by the service company, and the service company mediates users. The food service shop or hotel/inn 35 pays an information listing charge to the service company (S40).

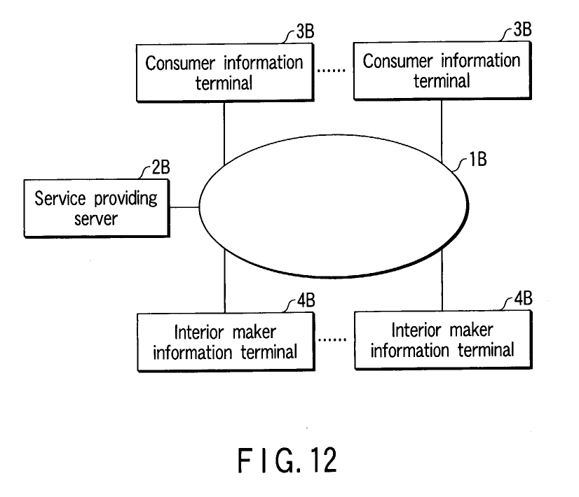

FIG. 12 is a schematic diagram showing the network system including the product purchase/product development support apparatus using the network, to which the product purchase/product development support method is applied according to a fourth embodiment of the present invention.

Internet 1B which is the network is connected to a service providing server 2B as the product purchase/product development support apparatus handled by the service provider which provides the product purchase/product development support service. This service providing server 2B is constituted of an information processing terminal, such as a computer, and functions as a server with respect to the Internet 1B.

Here, the Internet 1B may be either wired or wireless, as long as digital communication is performed. Moreover, a public line is also sometimes included.

The Internet 1B is connected not only to the service providing server 2B but also to a plurality of information terminals (consumers information terminals) 3B of consumers who purchase interior products, and a plurality of information terminals (interior maker information terminals) 4B of interior product makers which desire to participate in the purchase and development of the interior products.

In each consumers information terminal 3B and interior maker information terminal 4B, the browser is incorporated as the browsing software which can freely access the homepage of the service providing server 2B via the Internet 1B. Moreover, each consumers information terminal 3B and interior maker information terminal 4B have an E-mail transmission/reception function.

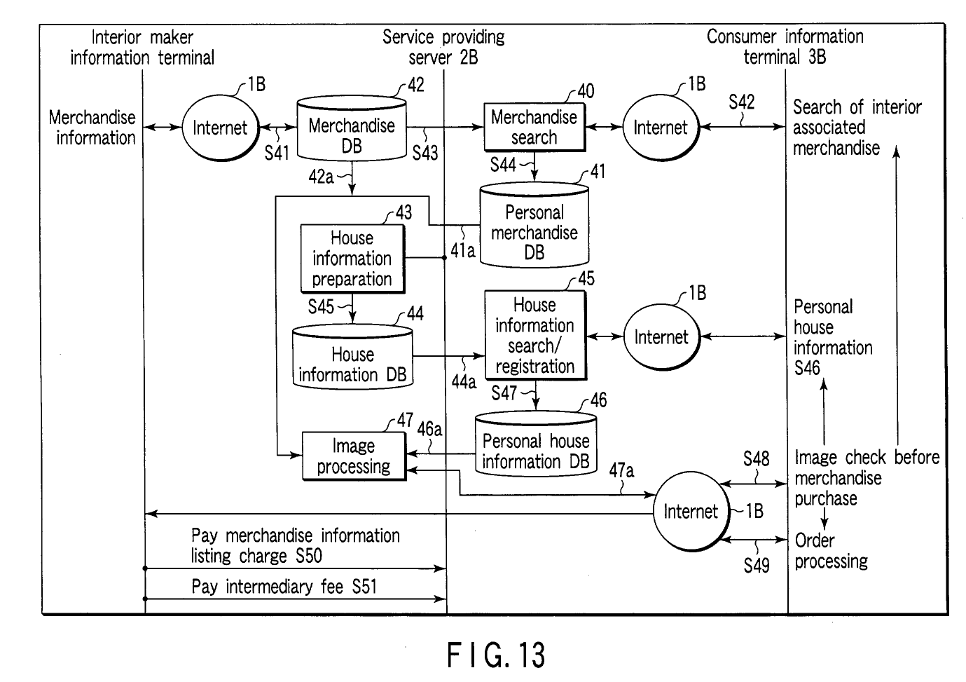

FIG. 13 is a sequence diagram in which the service providing server 2B incorporated in this network system indicates the procedures of various supports concerning the product purchase/product development to the consumers and interior maker.

Here, the service providing server 2B is described. The service providing server 2B includes: product search means 40; a personal product database (personal product DB) 41; a product database (product DB) 42; house information preparation means 43; a house information database (house information DB) 44; house information search/registration means 45; personal house information database (personal house information DB) 46; and image processing means 47.

In the product DB 42, product information of interior associated product makers from all interior associated company information terminals 4B such as information of lights is stored. For the personal product DB 41, when search conditions for searching for the interior associated product, such as use for a western or Japanese style room are inputted via the consumers information terminal 3B, the product meeting the search condition such as the light is selected, and the selected product information is stored.

The house information preparation means 43 prepares a layout of a general house as image information. In the house information DB 44, the image information of the layout of the general house prepared by the house information preparation means 43 is stored.

When the personal house information such as the layout of the house, the number of windows, size of a room, and color of a wall is inputted from the consumers information terminal 3B, the house information search/registration means 45 searches the image information of the layout of the general house stored in the house information DB 44 to prepare the personal house information as the image information. In the personal house information DB 46, the personal house information (image information) prepared by the house information search/registration means 45 is stored.

The image processing means 47 synthesizes image information 42a stored in the product DB 42, image information 41a of the personal product DB 41, and image information 46a stored in the personal house information DB 46 to prepare consumers simulated use image information 47a.

Next, an operation in the system constituted in this manner will be described. First, the product information of each interior associated product maker from the information terminal 4B of the interior associated product maker is stored in the product DB 42 (S41).

When the search condition for searching the interior associated product is inputted from the consumers information terminal 3B (S42), the product search means 40 selects the product meeting the search condition from the product DB 42 (S43), and stores the selected product information into the personal product DB 41 (S44).

Next, the house information preparation means 43 prepares the layout of the general house as the image information, and stores this in the house information DB 44 (S45). When the personal house information is inputted from the consumers information terminal 3B (S46), the house information search/registration means 45 searches the image information of the layout of the general house stored in the house information DB 44 to prepare the personal house information as the image information. This is stored in the personal house information DB 46 (S47).

Finally, the image processing means 47 synthesizes the image information 41a stored in the personal product DB 41 for each consumers, and image information 46a stored in the personal house information DB 46 for each consumers to obtain the consumers simulated use image information 47a. For the consumers simulated use image information 47a, when the consumers confirms an interior of a product to be purchased before the purchase of the interior product, and makes a request via the homepage prepared by the service company, the service company processes the image based on the product DB, personal product DB, and personal house information DB. The image can be outputted to the consumers information terminal 3B (S48).

As a result, when the consumers visually recognizes the consumers simulated use image information 47a of the consumers information terminal 3B, and purchases the interior product such as the light, the person performs a procedure of the order process from the consumers information terminal 3B (S59). Then, the service providing server 2B takes the order for the product, a district delivery center or living associated company (not shown) is instructed via the Internet 1B to ship the product, and the product is delivered to a consumers house.

In this case, whether the interior product is sold or not, a product information listing charge is paid to the service company owning the service providing server 2B from an interior maker (S50). Moreover, when the interior product is sold, the interior maker pays the intermediary fee to the service company owning the service providing server 2B (S51).

According to the fourth embodiment described above, the service providing server 2B gives the consumers simulated use image information 47a to the consumers information terminal 3B. The consumers can study the purchase of the interior product while at home before the purchase of the interior product. Additionally, even in a stage in which the interior product is purchased, the interior maker or delivery center can be instructed to deliver the product via the Internet 1B. Therefore, a quick response with respect to the consumers request is enhanced. On the other hand, since the service providing server 2B provides needs information to the interior maker information terminal 4B from the consumers, the information is useful for developing the products of the interior maker.

A product purchase/product development support method and product purchase/product development support apparatus according to the present invention are suitable for supporting consumers [those who purchase (consume) products made by makers such as a textile maker, food product maker, and interior associated product maker and lead a life] in purchasing a product, or for supporting the maker in developing the product.

What is claimed is:

1. A product purchase/product development support method of providing various information to a consumers who purchases a textile product and a textile maker which desires to participate in purchase and development of the textile product by a service providing server via a network to perform various supports, the method comprising:
a step of suggesting to store consumers information to data base including at least body shape and size information and appearance image information of the consumers who uses an information terminal of the consumers to be stored into a consumers information database disposed in the service providing server via the consumers information terminal connected to the network;
a step of suggesting fashion information of a product of the textile maker to be stored in a fashion database disposed in the service providing server via a textile maker's information terminal connected to the network;
a step of reading background information from a background database, fashion information from the fashion database, and consumers information from the consumers information database disposed in the service providing server and synthesizing this image information to prepare consumers simulated fitting image information by synthesized image calculation means disposed in the service providing server, when a simulated fitting request is inputted into the service providing server from the consumers information terminal;
a step of transmitting the consumers simulated fitting image information to the consumers information terminal by the service providing server; and
a step of receiving payment of an information listing charge by a service provider which owns the service providing server from the textile maker whose fashion information is registered in the fashion database.

2. The product purchase/product development support method according to claim 1, further comprising:
a step of suggesting interest or taste of the consumers who uses the consumers information terminal as consumers information to be stored in a consumers information database disposed in the service providing server via the consumers information terminal;
a step of reading the consumers information from the consumers information database, performing a trend analysis of a fashion field based on the information, and storing an analysis result into an analysis database disposed in the service providing server by trend analysis means disposed in the service providing server;
a step of transmitting the analysis data of the analysis database to the textile maker information terminal; and
a step of receiving payment of an analysis information providing fee from the textile maker by a service provider which owns the service providing server.

3. The product purchase/product development support method according to claim 1, further comprising:
a step of accepting an order request for the product by the service provider which owns the service providing server from the consumers via the consumers information terminal based on the consumers simulated fitting image information;
a step of instructing the textile maker information terminal corresponding to the order request to ship the product; and
a step of receiving payment of an intermediary fee by the service provider which owns the service providing server from the textile maker which has received the shipment instruction corresponding to the order request.

4. A product purchase/product development support method of providing various information to a consumers who purchases a textile product and a textile maker which desires to participate in purchase and development of the textile product by a service providing server via a network to perform various supports, the method comprising:
a step of suggesting a consumers fashion design which is inputted via a consumers information terminal connected to the network and which is prepared by the consumers to be stored into a consumers fashion database disposed in the service providing server;
a step of transmitting the consumers fashion design stored in the consumers fashion database to a textile maker's information terminal connected to the network to advertise for a textile maker which commercializes the consumers fashion design by fashion design processing means disposed in the service providing server, determining the textile maker for commercialization from textile makers which have responded to the advertisement, and storing sewing information of a pattern necessary for the commercialization into the fashion database disposed in the service providing server from the determined textile maker;
a step of suggesting consumers information including at least body shape and size information and appearance image information of the consumers who uses the consumers information terminal to be stored into a consumers information database disposed in the service providing server via the consumers information terminal;
a step of reading background information from a background database, fashion information from the fashion database, and consumers information from the consumers information database disposed in the service providing server by the service providing server, and synthesizing this image information to prepare consumers simulated fitting image information by synthesized image calculation means disposed in the service providing server, when a simulated fitting request is inputted into the service providing server from the consumers information terminal;
a step of transmitting the consumers simulated fitting image information to the consumers information terminal by the service providing server; and
a step of paying a design use fee to the consumers who has prepared the consumers fashion design directly from the textile maker or via a service provider, when the consumers fashion design stored in the consumers fashion database is stored in the fashion database and opened to the public via the consumers information terminal and the opened fashion is used.

5. The product purchase/product development support method according to claim 4, further comprising:
a step of suggesting interest or taste of the consumers who uses the consumers information terminal as consumers information to be stored in a consumers information database disposed in the service providing server via the consumers information terminal;
a step of reading the consumers information from the consumers information database, performing a trend analysis of a fashion field based on the information, and storing an analysis result into an analysis database disposed in the service providing server by trend analysis means disposed in the service providing server;
a step of transmitting the analysis data of the analysis database to the textile maker information terminal; and
a step of receiving payment of an analysis information providing fee from the textile maker by a service provider which owns the service providing server.

6. The product purchase/product development support method according to claim 4, further comprising:
a step of accepting an order request for the product by the service provider which owns the service providing server from the consumers via the consumers information terminal based on the consumers simulated fitting image information;
a step of instructing the textile maker information terminal corresponding to the order request to ship the product; and
a step of receiving payment of an intermediary fee by the service provider which owns the service providing server from the textile maker which has received the shipment instruction corresponding to the order request.

7. A product purchase/product development support apparatus comprising: a service providing server to provide various information to a consumers who purchases a textile product and a textile maker which desires to participate in purchase and development of the textile product via a network, so that various supports are performed,
the service providing server comprising: a consumers information database; a fashion database; a background database; and synthesized image calculation means,
wherein the consumers information database stores consumers information inputted from the consumers information terminal and comprising at least body shape size information and appearance image information of the consumers who uses the consumers information terminal,
the service providing server suggests fashion information of a product of the textile maker, which is inputted from a textile maker's information terminal connected to the network, to be stored into the fashion database,
the service providing server stores background information into the background database, and the synthesized image calculation means reads the background information from the background database, fashion information from the fashion database, and consumers information from the consumers information database and synthesizes these image information to prepare consumers simulated fitting image information, when receiving a simulated fitting request from the consumers information terminal.

8. The product purchase/product development support apparatus according to claim 7,
wherein the service providing server further comprises: trend analysis means; and an analysis database,
the service providing server suggests the consumers information comprising the body shape and size information and appearance image information of the consumers who uses the consumers information terminal to be stored in the consumers information database via the consumers information terminal, and additionally suggests interest or taste of the consumers who uses the consumers information terminal as the consumers information to be stored, and
the trend analysis means reads the consumers interest or taste from the consumers information stored in the consumers information database, performs a trend analysis of a fashion field based on the information, stores a trend analysis result into an analysis database, and transmits the analysis result to the textile maker information terminal.

9. The product purchase/product development support apparatus according to claim 7, wherein the service providing server further comprises: order acceptance processing means, and
the order acceptance processing means accepts an order request of the product from the consumers information terminal with respect to a service provider which owns the service providing server, and transmits a shipment instruction of the product to the textile maker information terminal corresponding to the order request.

10. A product purchase/product development support apparatus comprising: a service providing server to provide various information to a consumers who purchases a textile product and a textile maker which desires to participate in purchase and development of the textile product via a network, so that various supports are performed,
the service providing server comprising: a consumers fashion database; fashion design processing means; a fashion database; a consumers information database; a background database; synthesized image calculation means; and order acceptance processing means,
wherein the service providing server suggests a consumers fashion design which is inputted from a consumers information terminal connected to the network and which is prepared by the consumers to be stored in the consumers fashion database,
the fashion design processing means transmits the consumers fashion design stored in the consumers fashion database to a textile maker's information terminal connected to the network to advertise for a textile maker which commercializes the consumers fashion design, determines the textile maker for commercialization from textile makers which have responded to the advertisement, and suggests sewing information of a pattern necessary for the commercialization to be stored into the fashion database from the determined textile maker,
the consumers information database suggests consumers information comprising at least body shape and size information and appearance image information of the consumers who uses the consumers information terminal to be stored via the consumers information terminal,
the synthesized image calculation means reads background information from the background database, fashion information from the fashion database, and consumers information from the consumers information database, synthesizes this image information to prepare consumers simulated fitting image information, and transmits the consumers simulated fitting image information to the consumers information terminal, when a simulated fitting request is inputted into the service providing server from the consumers information terminal, and
the order acceptance processing means accepts an order for a product from the consumers information terminal, after the consumers simulated fitting image information is received in the consumers information terminal, and instructs the information terminal of the textile maker which has commercialized the consumers fashion design to ship the product.

11. The product purchase/product development support apparatus according to claim 10,
wherein the service providing server further comprises: trend analysis means; and an analysis database,
the service providing server suggests the consumers information comprising the body shape size information and appearance image information of the consumers who uses the consumers information terminal to be stored in the consumers information database via the consumers information terminal, and additionally suggests interest or taste of the consumers who uses the consumers information terminal as the consumers information to be stored, and
the trend analysis means reads the consumers interest or taste from the consumers information stored in the consumers information database, performs a trend analysis of a fashion field based on the information, stores a trend analysis result into an analysis database, and transmits the analysis result to the textile maker information terminal.

12. The product purchase/product development support apparatus according to claim 10, wherein the service providing server further comprises: order acceptance processing means, and
the order acceptance processing means accepts an order request of the product from the consumers information terminal with respect to a service provider which owns the service providing server, and transmits a shipment instruction of the product to the textile maker information terminal corresponding to the order request.

13. A product purchase/product development support method of providing various information to a consumers who purchases a food product and a food product maker which desires to participate in purchase and development of the food product by a service providing server via a network to perform various supports, the method comprising:
a step of suggesting a content of check of an eating habit including a personal health condition of the consumers by a nutrition management adviser who has contracted with a service provider owning the service providing server to be stored in a consumers information database disposed in the service providing server via the service providing server;
a step of analyzing a content stored in the consumers information database to prepare food product manufacturing/developing information for manufacturing/developing the food product fit for consumers needs by analysis processing means disposed in the service providing server;
a step of suggesting an existing food product list from a food product maker's information terminal connected to the network and a new food product list newly developed based on the food product manufacturing/developing information stored in an analysis database to be stored in a food product database disposed in the service providing server; and
a step of searching the consumers information database, a menu database in which all menus are stored, a recipe database in which a recipe corresponding to the menu is stored, and the food product database, and supplying a menu for each consumers, food products necessary for the menu, and recipe of the food products to a consumers information terminal connected to the network by menu preparation means disposed in the service providing server.

14. The product purchase/product development support method according to claim 13, further comprising:
a step of receiving an order/delivery request for the food product necessary for the menu suitable for the consumers obtained from the menu preparation means by the service providing server from the consumers information terminal to transmit the request to the food product maker information terminal; and
a step of delivering the food product corresponding to the request to a place designated by the consumers who has requested order/delivery of the food product on a side of the food product maker which has received the request for the order/delivery of the food product.

15. The product purchase/product development support method according to claim 13, further comprising:
a step of accepting a request for cooking the menu suitable for the consumers obtained from the menu preparation means from the consumers information terminal; and a step of transmitting the request to a cooking company terminal connected to the network other than the consumers side, after accepting the request for cooking the menu by the service providing server, and cooking the menu by the corresponding cooking company.

16. A product purchase/product development support apparatus comprising: a service providing server to provide various information to a consumers who purchases a food product and a food product maker which desires to participate in purchase and development of the food product via a network, so that various supports are performed,
the service providing server comprising: a consumers information database; a menu database; a recipe database; an analysis database; a food product database; eating habit check result input means; analysis processing means; and menu preparation means,
wherein the eating habit check result input means suggests a content of check of an eating habit including a personal health condition of the consumers by a nutrition management adviser who has contracted with a service provider owning the service providing server to be stored in the consumers information database;
the analysis processing means analyzes the content stored in the consumers information database to prepare food product manufacturing/developing information for manufacturing/developing the food product fit for consumers needs;
the analysis processing means suggests the food product manufacturing/developing information prepared by the analysis processing means to be stored in the analysis database, and transmits the stored food product manufacturing/developing information to a food product maker's information terminal connected to the network, and
suggests an existing food product list from the food product maker information terminal and/or a new food product list newly developed based on the food product manufacturing/developing information stored in the analysis database to be stored in the food product database,
the menu database stores all menus,
the recipe database registers a recipe for each menu, and
the menu preparation means transmits the menu for each consumers, food products necessary for the menu, and recipe of the food products to a consumers information terminal connected to the network based on the consumers information database, menu database, recipe database, and food product database.

17. The product purchase/product development support apparatus according to claim 16, wherein the service providing server further comprises order acceptance processing means for instructing the food product maker information terminal to order/deliver the food product necessary for the menu for each consumers obtained from the consumers terminal.

18. The product purchase/product development support apparatus according to claim 16, wherein the service providing server further comprises order acceptance processing means for supplying the menu for each consumers obtained from the consumers terminal to a cooking company terminal connected to the network to issue an instruction for cooking the menu.

19. A product purchase/product development support method of providing various information to a consumers who purchases an interior associated product and an interior associated product maker which desires to participate in purchase and development of the interior associated product by a service providing server via a network to perform various supports, the method comprising:
a step of suggesting product information of each interior associated product maker from an information terminal of the interior associated product maker connected to the network to be stored into a product database disposed in the service providing server;
a step of suggesting an information terminal of the consumers connected to the network to input a search condition for searching the interior associated product, selecting a product satisfying the search condition from the products stored in the product database, when the search condition is inputted, and suggesting image information of the selected product to be stored in a personal product database disposed in the service providing server;
a step of suggesting the consumers information terminal to store the image information concerning a house into a house information database disposed in the service providing server by the service providing server;
a step of suggesting the consumers information terminal to store personal house information inputted from the consumers information terminal as the image information into a personal house information database disposed in the service providing server by the service providing server;
a step of synthesizing the image information stored in the personal product database and image information stored in the personal house information database to prepare consumers simulated use image information by image processing means disposed in the service providing server; and
a step of transmitting the consumers simulated use image information synthesized by the image processing means to the consumers information terminal.

20. A product purchase/product development support apparatus comprising: a service providing server to provide various information to a consumers who purchases an interior associated product and an interior associated product maker which desires to participate in purchase and development of the interior associated product via a network, so that various supports are performed,
the service providing server comprising: a product database; product search means; a personal product database; a personal house information database; and image processing means,
wherein the service providing server suggests product information of each interior associated product maker from information terminals of a plurality of interior associated companies connected to the network to be stored into the product database,
the product search means selects a product satisfying a search condition from the product database, when the search condition for searching the interior associated product is inputted from an information terminal of the consumers connected to the network, and stores image information of the selected product into the personal product database,
the service providing server suggests the consumers information terminal to store personal house information as the image information into the personal house information database, and
the image processing means synthesizes the image information stored in the personal product database and image information stored in the personal house information database to prepare consumers simulated use image information, and transmits the prepared consumers simulated use image information to the consumers information terminal.
